(19) United States
(12) Patent Application Publication
(10) Pub. No.: US 2026/0027572 A1
(43) Pub. Date: Jan. 29, 2026

(54) SPRAY RING NOZZLE INTERFACE ASSEMBLY

(71) Applicant: Kohler Mira Limited, Cheltenham (GB)

(72) Inventors: John Adey, Cheltenham Gloucestershire (GB); James Bourne, Cheltenham (GB)

(21) Appl. No.: 19/269,865

(22) Filed: Jul. 15, 2025

Related U.S. Application Data
(60) Provisional application No. 63/676,567, filed on Jul. 29, 2024.

(51) Int. Cl. B05B 1/30; B05B 1/18; E03C 1/02; E03C 1/04

(52) U.S. Cl. CPC B05B 1/3006; B05B 1/182; E03C 1/0408; E03C 2001/026

(57) ABSTRACT

Provided herein is a leak prevention system for an ablutionary fitting such as a shower head. The leak prevention system includes a nozzle configuration for the ablutionary fitting, the nozzle configuration including a plurality of nozzles configured to dispense water supplied to the ablutionary fitting and a plurality of nozzle pins positioned in the plurality of nozzles. The nozzle pins operate to selectively allow and limit flow of water through the nozzles in response to variations in pressure of the water supplied to the ablutionary fitting. For example, when water is actively being supplied to the ablutionary fitting, the nozzle pins may allow the water to flow through the nozzles. When the water supply is shut off, the nozzle pins may facilitate limiting the flow of water through the nozzles via water surface tension forces that develop between the nozzle pins and the nozzles.

### CROSS-REFERENCE TO RELATED APPLICATION

This application claims priority to U.S. Provisional Application No. 63/676,567, filed Jul. 29, 2024, the entire disclosure of which is hereby incorporated herein by reference.

### TECHNICAL FIELD

The present disclosure relates generally to the field of water distribution systems and, more particularly, to inserts that facilitate reducing or preventing leakage or dripping in ablutionary fittings such as shower heads.

### BACKGROUND

Conventional shower heads may include a housing with a plurality of outlets allowing water to flow from the shower head. The flow of water typically needs to be shut off upstream from the shower head via an additional flow control device to stop the water from flowing through the shower head.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is an example of an ablutionary fitting.

FIG. 2 is an example of a nozzle configuration.

FIG. 3 is an exploded view of a portion of a nozzle configuration.

FIG. 4 is a perspective view of a portion of a nozzle configuration.

FIG. 5 is a cross-sectional view of a nozzle configuration taken across an X-Y-plane.

FIG. 6 is a cross-sectional view of a nozzle configuration taken across an X-Y plane.

FIG. 7 is cross-sectional view of a portion of a nozzle configuration taken across an X-Z plane.

FIG. 8 depicts an operation for a method of assembling an ablutionary fitting that includes a nozzle configuration.

FIG. 9 depicts an operation for a method of assembling an ablutionary fitting that includes a nozzle configuration.

FIG. 10 is an example of an ablutionary system.

Corresponding reference numerals used throughout the drawings indicate corresponding elements and components.

### DETAILED DESCRIPTION OF THE DRAWINGS

The present disclosure relates to a leak prevention system for an ablutionary fitting, such as a shower head. The system includes a nozzle configuration that may be incorporated into an outlet housing of the ablutionary fitting to limit or prevent water from dripping or leaking after shut-off. The outlet housing of the ablutionary fitting may be configured to receive inlet water and may include a plurality of outlets to dispense water from the outlet housing. The nozzle configuration may be coupled to and/or within the outlet housing and may include a plurality of nozzles coupled to a nozzle base. Each nozzle may align with an associated one of the plurality of outlets of the outlet housing. Additionally or alternatively, the nozzles may define the outlets. The nozzle configuration may also include a plurality of nozzle pins inserted into the plurality of nozzles. The plurality of nozzle pins may be configured to create a choke point with increased contact surface area within the plurality of nozzles. When supply of the water to the ablutionary fitting is shut off, the plurality of nozzle pins may facilitate limiting or restricting flow of water through the nozzles via surface tension forces and relatively low pressure of the residual water in the nozzles. This may facilitate the reduction or stoppage of water from leaking from the nozzles and outlets.

Additional features and advantages are provided by the present disclosure, which can be realized by the following detailed description. The figures illustrate exemplary systems involving ablutionary systems by way of example. The present disclosure is not limited to the details or methodology set forth in the description or illustrated in the figures. The terminology used in this disclosure is for the purpose of description only and should not be regarded as limiting.

The present disclosure is disclosed in the context of shower systems but not limited to shower systems. Aspects of the present disclosure that are depicted in the illustrated embodiments or otherwise described herein may be used in conjunction with other ablutionary fittings or water distribution systems. Water distribution systems encompassed by the present disclosure include, without limitation, water distribution systems that dispense water for consumption and/or washing and water distribution systems used for private, public, domestic, residential, commercial, and/or industrial use. Water distribution systems such as, for example and without limitation, showers, baths, washtubs, hot tubs, sinks, fountains, water dispensers, and the like may incorporate aspects of the present disclosure and are encompassed herein. Example water distribution systems may include an outlet fitting dispensing water or other fluid. The outlet fitting may include any suitable device that is configured to dispense liquid or water. The outlet fitting may include an ablutionary fitting, such as, for example and without limitation, a shower head, shower spray, wand hand shower, faucet, wand, spigot, tap, spout, or the like. The outlet fitting can include a single outlet fitting or more than one outlet fitting. Where the outlet fitting includes multiple, e.g., two or more outlet fittings, the outlet fittings can be similar types of outlet fittings or dissimilar types of outlet fittings. Elements and features described with reference to one illustrated embodiment are not limited to that embodiment only; the features and elements of any one or more of the illustrated embodiments can be utilized in any other embodiment in any combination.

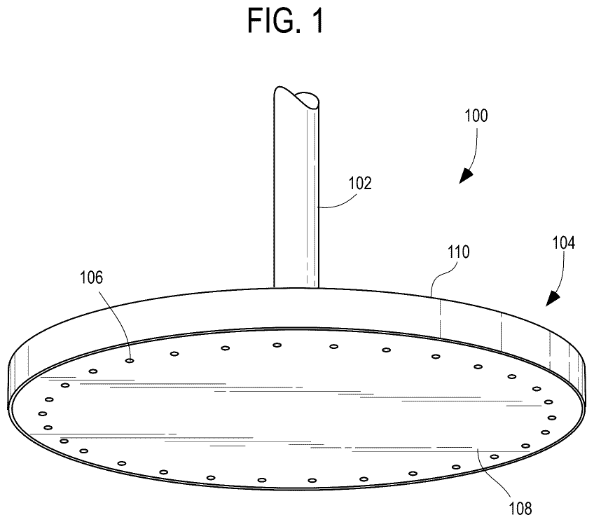

FIG. 1 is an example of an ablutionary fitting 100, also referred to as an outlet fitting, configured to dispense water or other liquid. A nozzle configuration may be implemented in the ablutionary fitting 100 to limit or prevent water from leaking or dripping from the ablutionary fitting 100. In the illustrated example, the ablutionary fitting 100 may include a shower head. The ablutionary fitting 100 may also be referred to as a shower head in the context of FIG. 1. Aspects of the ablutionary fitting 100 are not limited to shower heads and may be incorporated in other ablutionary fittings configured to dispense water or other liquid.

The ablutionary fitting 100 may be usable in a water distribution system, such as a shower system. For example, the ablutionary fitting 100 may be coupled to an ablutionary fixture 102, such as an overhead shower arm or other shower fixture, that supplies water to the ablutionary fitting 100. The ablutionary fixture 102 may include integrated water piping to provide hot water, cold water, or a mixture thereof to the shower head 100. The ablutionary fixture 102 may be coupled or mounted to any suitable structure within or proximate to a space in which water is dispensed via the ablutionary fitting 100. For example, the ablutionary fixture 102 may be coupled or mounted to a base, floor, wall, ceiling, cabinet, countertop, or the like. In examples where the ablutionary fitting 100 is a shower head, the ablutionary fixture 102 may be coupled or mounted to a ceiling, base, floor, or a wall of a shower space such that water dispensed via the ablutionary fitting 100 may flow into the shower space. The ablutionary fixture 102 may be rotatable or otherwise adjustable relative to a mounting structure to adjust a position and/or direction of the water being dispensed via the ablutionary fitting 100 into the space.

The ablutionary fitting 100 may include a housing 104 coupled to the ablutionary fixture 102. The housing 104 may have a substantially rounded, e.g., circular or disk, shape; however, the shape of the housing 104 is not particularly limited and the housing 104 can have any suitable shape. The housing 104 may include a plurality of outlets 106 integrated into or defined in a first portion 108, e.g., a base or bottom portion, of the housing 104. The plurality of outlets 106 may be fluidly coupled to the ablutionary fixture 102. The water supplied to the ablutionary fitting 100 via the ablutionary fixture 102 may be dispensed via the plurality of outlets 106 into a space, such as a shower space. The housing 104 may also include a second portion 110, e.g., a cover or a top portion, aligned and coupled to the first portion 108. In examples, the housing 104 may be configured to be constructed of a single piece, or multiple pieces. Preferably, the housing 104 may have a fluid-tight or water-tight configuration such that the water supplied to the ablutionary fitting 100 exits via the plurality of outlets 106 and the housing 104 is otherwise sealed to limit or prevent water from exiting from another region of the housing 104.

The plurality of outlets 106 may be arranged or configured in a variety of different design variations. The arrangement or configuration of the plurality of outlets 106 may be selected according to a desired flow pattern or flow type of the water being dispensed via the ablutionary fitting. For example, an exemplary set of outlets 106 that are circumferentially arranged on the first portion 108 proximate a peripheral edge of the ablutionary fitting 100 is depicted, which may resemble a “chandelier” type shower head. However, while a “chandelier” type shower head may be depicted, other variations outlet configurations may be included, such as, for example and without limitation, additional circumscribed inner outlets, rotatable or spiral patterns with inner or surrounding outlets, etc.

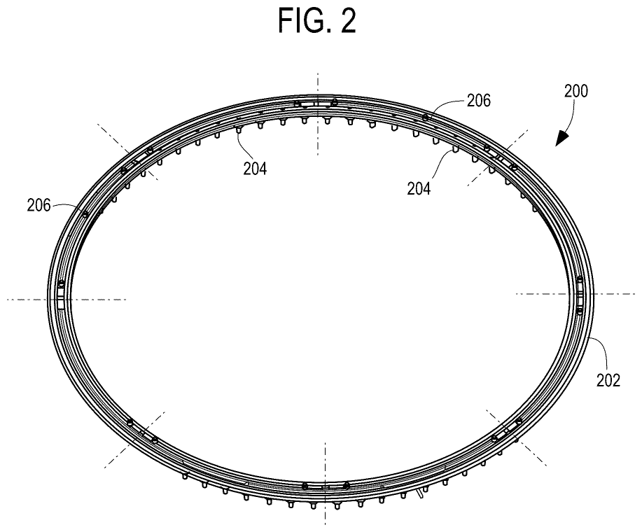

FIG. 2 depicts a nozzle configuration 200 that may be included in an ablutionary fitting, such as the ablutionary fitting 100 of FIG. 1. The nozzle configuration 200 may be configured to be inserted into or integrated with a housing of the ablutionary fitting, such as the housing 104 of FIG. 1. A shape of the nozzle configuration 200 may complement a shape of the housing and/or an arrangement of outlets of the ablutionary fitting. For example, the nozzle configuration 200 may be substantially rounded in shape, e.g., has a circular shape or ring shape, such that the nozzle configuration 200 may be conformed to fit within or be integrated with the housing 104 of the ablutionary fitting 100.

The nozzle configuration 200 may include a nozzle base 202 including one or more individual nozzles 204. A number of nozzles 204 may correspond to the number of outlets of the ablutionary fitting in which the nozzle configuration 200 is incorporated. For example, the nozzle configuration 200 may be incorporated in the ablutionary fitting 100 of FIG. 1 and the number of nozzles 204 may correspond to the number of the outlets 106. The nozzles 204 may be configured to conform to the shapes and positions of the outlets of the ablutionary fitting, and each one of the nozzles 204 may be associated with a respective one of the outlets. The nozzles 204 may be inserted into pathways of the associated outlets when inserted into or integrated with the housing of the ablutionary fitting. For example, each one of the nozzles 204 may be inserted into a pathway or opening of an associated one of the outlets 106 of the ablutionary fitting 100. Each one of the nozzles 204 may include a nozzle passage that allows the water to be dispensed via the nozzles 204 and the outlets. Additionally or alternatively, the nozzles 204 may define the outlets of the ablutionary fitting. For example, the nozzle configuration 200 may be inserted into or integrated with the housing of the ablutionary fitting such that the nozzles 204 define the outlets of the ablutionary fitting.

The nozzle configuration 200 may also include one or more nozzle inserts 206 that may couple to or are seated on the nozzle base 202. The nozzle inserts 206 may facilitate limiting or preventing water from leaking or dripping out of the ablutionary fitting when supply of water to the ablutionary fitting is shut off. For example, the nozzle inserts 206 may facilitate sealing a water flow path through the nozzles 204 and the outlets of the ablutionary fitting when supply of water to the ablutionary fitting is shut off. In this way, the nozzle inserts 206 may facilitate automated reduction or prevention of water leakage or dripping from the nozzles 204.

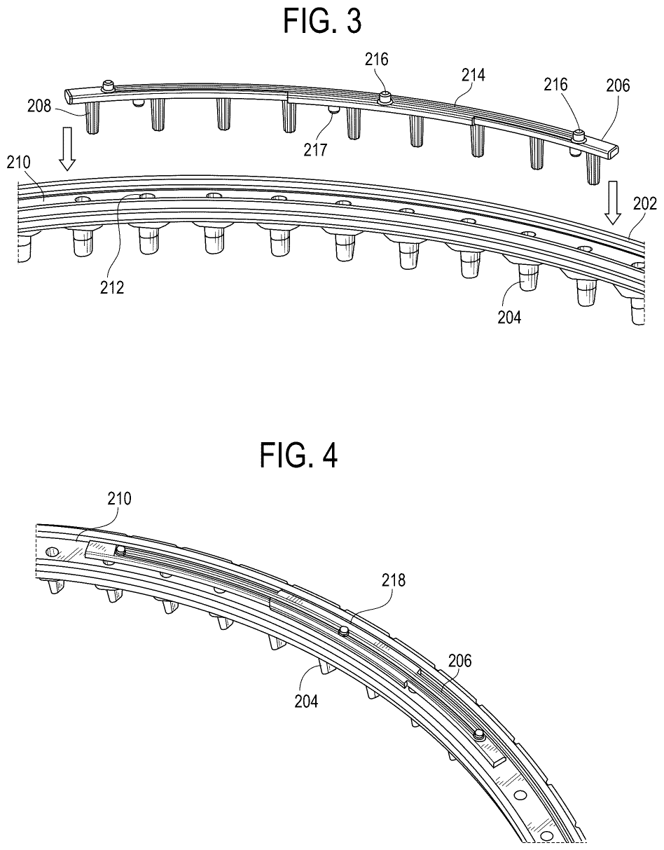

Referring to FIG. 3, the nozzle inserts 206 may comprise a plurality of nozzle pins 208 extending outwardly, e.g., downwardly, from a main body of the nozzle insert 206. Each nozzle pin 208 may be configured to be received by an associated one of the nozzles 204. The nozzle pins 208 may be sized and shaped to selectively allow, and limit or restrict, water flow through the nozzles 204 via variations in pressure of the water flowing between the nozzle pins 208 and the nozzles 204. For example, the nozzle pins 208 may be sized and shaped to selectively allow water to pass through the nozzles 204 and the outlets at relatively higher pressures such as when water is actively being supplied to the ablutionary fitting. The nozzle pins 208 may be sized and shaped to selectively limit or restrict water flow through the nozzles 204 at relatively lower pressures such as when water flow to the ablutionary fitting is shut off.

A number of the nozzle pins 208 may correspond to the number of nozzles 204 of the nozzle base 202. For example, each one of the nozzles 204 may receive a nozzle pin 208. Alternatively, fewer nozzle pins 208 than nozzles 204 may be included such that only some of the nozzles 204 receive a nozzle pin 208.

The nozzle configuration 200 may include one nozzle insert 206 that includes the nozzle pins 208 or multiple nozzle inserts 206 that each include one or some of the nozzle pins 208. Where a single nozzle insert 206 is included, the nozzle insert 206 may be a unitary structure having a shape that complements the shape of the nozzle base 202. For example, the nozzle insert 206 may be a unitary ring or circle that complements the ring or circular shape of the nozzle base 202. Where multiple nozzle inserts 206 are included, each nozzle insert 206 may be a segment that cooperates with the other nozzle inserts 206 to form a shape that complements the shape of the nozzle base 202. For example, multiple nozzle inserts 206 may each be in the shape of an arcuate segment and may cooperate to define a ring or circle that complements the ring or circular shape of the nozzle base 202. The single nozzle insert 206 or multiple nozzle inserts 206, together with the nozzle base 202, may extend along the outlets of the ablutionary fitting. In the illustrated example, multiple nozzle inserts 206 may be included and are delineated by dashed lines in FIG. 2. For example, eight nozzle inserts 206 may be included. However other configurations and numbers of nozzle inserts may be included to conform to the nozzle base 202 and the size, shape, design, and number of outlets of the ablutionary fitting. For example, in smaller shower heads, a smaller nozzle base and fewer nozzle inserts may be implemented. In examples where a shower head has multiple rows of outlets incorporated, additional nozzle configurations 200 may be implemented of varying sizes that may be associated with different sized rows or arrangements of outlets. Additionally, while the nozzle base 202 may be depicted as a single piece, similar to the nozzle inserts 206, the nozzle base 202 may be constructed of one or more pieces or segments.

The nozzle insert(s) 206 may be received by, or positioned in, a recess 210 of the nozzle base 202 when coupled or mounted to the nozzle base 202. Each one of the nozzle pins 208 may align with and be received by a nozzle hole 212 of the associated one of the nozzles 204 when the nozzle insert(s) 206 are received by the recess 210. FIG. 3 depicts an example where a nozzle insert 206 is one of multiple nozzle inserts 206 and includes nine nozzle pins 208. The nine nozzle pins 208 of this example may align with and may be received by nine associated nozzle holes 212. As another example, for an ablutionary fitting that includes seventy-two outlets to dispense water, the nozzle base 202 may include seventy-two nozzles 204 and the insert(s) 206 may include seventy-two nozzle pins 208 or fewer than seventy-two nozzle pins 208. Continuing with this example, if eight nozzle inserts 206 are included, each nozzle insert 206 may include nine nozzle pins 208 or fewer than nine nozzle pins 208. The multiple, e.g., eight, nozzle inserts 206 may be arranged in an end-to-end pattern to circumscribe the nozzle base 202. It should be understood that while a particular number of nozzles 204, nozzle inserts 206, and nozzle pins 208 have been depicted, alternative and additional quantities, patterns, etc. may be utilized.

Each nozzle insert 206 may include one or more stiffening ribs 214. The stiffening rib(s) 214 may facilitate strengthening and increasing a durability of the nozzle insert 206. The stiffening rib(s) 214 may also facilitate stabilizing the nozzle insert 206 within the recess 210. The stiffening rib(s) 214 may extend along an entire circumferential or arcuate length of the nozzle insert 206. Alternatively, the stiffening rib(s) 214 may extend along only a portion of the circumferential or arcuate length of the nozzle insert 206.

Each nozzle insert 206 may additionally or alternatively include positioning features, e.g., bosses 216, 217, that facilitate maintaining a position of the nozzle insert 206 within the recess 210. The bosses 216, 217 may also facilitate maintaining a depth that the nozzle pins 208 are received in the associated nozzle holes 212. This may facilitate limiting or preventing the nozzle pins 208 from shifting in the nozzle holes 212 during operation of the ablutionary fitting which could otherwise impede or hinder the function of the nozzle pins 208. For example, if the depth of the nozzle pins 208 in the nozzle holes 212 is too great, the nozzle pins 208 may undesirably limit or restrict flow of the water through the nozzles 204 when the water is being supplied to the ablutionary fitting. If the depth of the nozzle pins 208 in the nozzle holes 212 is too shallow, the nozzle pins 208 may not sufficiently limit or restrict flow of the water through the nozzles 204 when the water supplied to the ablutionary fitting is shut off.

The bosses 216, 217 of the nozzle insert 206 may include one or more anti-removal bosses 216 positioned along a top of the nozzle insert 206. For example, the anti-removal bosses 216 may protrude upwardly from the stiffening rib(s) 214. The anti-removal bosses 216 may be positioned proximate a structure, such as a plate, extending across the nozzle insert(s) 206 and the nozzle base 202. The anti-removal bosses 216 may abut the structure to limit or prevent movement of the nozzle insert 206, e.g., upward movement of the nozzle insert 206 relative to the nozzle base 202. Additionally or alternatively, the anti-removal bosses 216 may abut the structure to limit or prevent upward movement of the nozzle insert 206 and the nozzle base 202 relative to the housing of the ablutionary fitting. The structure may be an internal structure within the housing of the ablutionary fitting. Such an internal structure may include inlets defined therein that allow water supplied to the ablutionary fitting to flow through the structure and toward the nozzles 204 and the outlets. Alternatively, the structure may be a cover of the housing of the ablutionary fitting, such as the cover 110 of the housing 104 of FIG. 1. The anti-removal bosses 216 may additionally or alternatively facilitate maintaining the structure and integrity of the stiffening ribs 214 and/or maintaining a position of the stiffening ribs 216 relative to the nozzle insert 206 and nozzle base 202. Three anti-removal bosses 216 may be included in the illustrated example for the nozzle insert 206, however more or fewer anti-removal bosses 216 may be included. For example, more anti-removal bosses 216 may be included for nozzle inserts 206 that have a relatively longer circumferential or arcuate length, and fewer anti-removal bosses 216 may be included for nozzle inserts 206 that have a relatively shorter circumferential or arcuate length.

The bosses 216, 217 of the nozzle insert 206 may additionally or alternatively include one or more height bosses 217 positioned along a bottom of the nozzle insert 206. For example, the height bosses 217 may protrude downwardly from the bottom of the nozzle insert 206 opposite the anti-removal bosses 216. The height bosses 217 may be positioned proximate a floor of the recess 210 of the nozzle base 202. The height bosses 217 may abut the floor of the recess 210 to limit or prevent movement of the nozzle insert 206, e.g., downward movement of the nozzle insert 206 relative to the nozzle base 202. The height bosses 217 may facilitate maintaining the depth of the nozzle insert 206 within the recess 210 and/or the depth of the nozzle pins 208 within the nozzle holes 212. Maintaining the depth of the nozzle inserts 206 relative to nozzle base 202 and/or the depth of the nozzle pins 208 within the nozzle holes 212 may facilitate the nozzle pins 208 ability to selectively control the flow of the water through the nozzles 204 via the nozzle pins 208 using the variations in water surface tension and/or pressure.

The height bosses 217 may additionally or alternatively provide a height clearance between the main body of the nozzle insert 206 and the floor of the recess 210. The recess 210 may define a trough or channel through which the water supplied to the ablutionary fitting flows between the nozzles 204 and the outlets. The recess 210 may thereby facilitate distributing the water between the nozzles 204 and the outlets. The height clearance provided by the height bosses 217 may enable the water to flow between the main body of the nozzle insert 206 and the floor of the recess 210 toward the nozzles 204 and the outlets.

With reference to FIG. 4, the main body of each nozzle insert 206 may include a wider central section 218, relative to the remaining portion of main body of the nozzle insert 206. Lateral edges of the main body of the nozzle insert 206 at the wider central section 218 may be positioned proximate or may abut the lateral edges of the recess 210. This may provide stability for the nozzle insert 206 within the recess 210. Additionally or alternatively, the wider central section 218 of each nozzle insert 206 may provide inlet protection for the nozzles 204 and/or may facilitate distributing water flow in the recess 210. The wider central section 218 of each nozzle insert 206 may align with inlets for the water supplied to the ablutionary fitting, e.g., inlets defined in an internal structure or plate positioned within the housing of the ablutionary fitting. The wider central sections 218 may operate as baffles or flow directors for the incoming water, distributing the water via the inlets outward such that the incoming flow of water does not concentrate at the nozzles 204 within the immediate vicinity of the inlets.

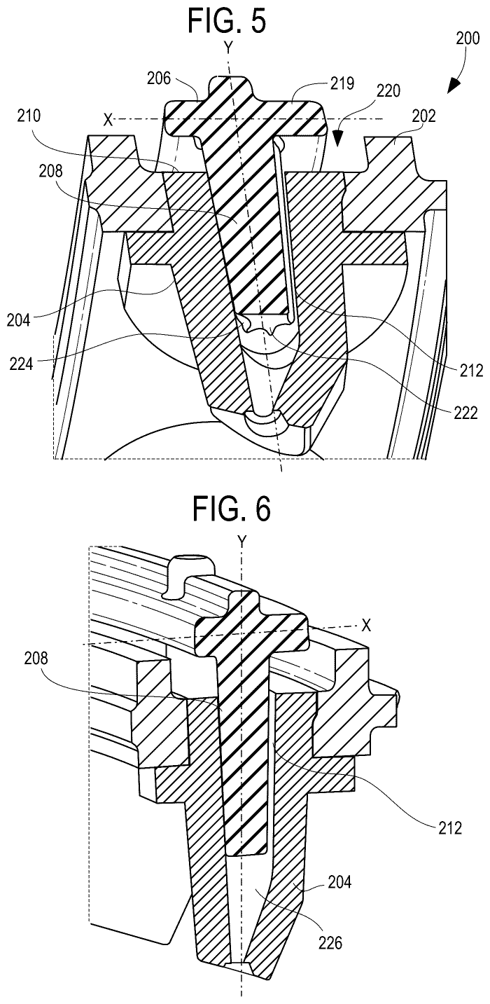

FIG. 5 depicts a cross-sectional view across an X-Y plane of the nozzle configuration 200 showing a nozzle insert 206 positioned within the recess 210 and a nozzle pin 208 received by a nozzle hole 212 of a nozzle 204. The main body of the nozzle insert 206 may be elevated or raised relative to the floor of the recess 210, e.g., via the height bosses 217 shown in FIG. 3. The nozzle pin 208 may be received by the nozzle hole 212 at a suitable depth, which may also be controlled via the height bosses 217 shown in FIG. 3. The nozzle pin 208 may be configured to allow water pressure to force water flow through the nozzle 204. The main body of the nozzle insert 206 may define nozzle overlaps or flaps 219 extending laterally outward relative to the nozzle pin 208. The flaps 219 may, at least partially, overlap the nozzle holes 212 of the nozzle base 202. The flaps 219 may be coupled or joined to the nozzle pins 208. Flow passages 220 may be defined between the flaps 219 and the recess 210.

When water is supplied to the ablutionary fitting, the water may flow through recess 210 via the flow passages 220 toward the nozzles 204. The pressure of the water may force the water to flow through the nozzle holes 212 between the nozzle pin 208 and the nozzle 204. The water may exit the nozzles 204 and the outlets of the ablutionary fitting and is subsequently dispensed into a space such as a shower space.

The nozzle pins 208 may be sized and shaped to control the flow path of water through the associated nozzle holes 212. For example, the nozzle pins 208 may be sized to define discrete flow channels in the nozzle holes 212 for flow of the water therethrough. In the illustrated example, each nozzle pin 208 has a cross-section in the shape of a star, with a plurality of arms 222 and indentations. The arms 222 may extend outwardly. The star shape of the nozzle pin 208 defines discrete passageways 224 between the nozzle pin 208 and the nozzle 204. Water flow may flow through the recess 210 via the passages 220 and may flow through the nozzle hole 212 via the discrete passageways 224. The reduced volume of the nozzle hole 212 via the nozzle insert 208 may facilitate pressurizing the water as it flows through the discrete passageways 224. It should be understood that while a star shaped nozzle pin 208 is depicted, alternative shapes, sizes, designs, etc. may be utilized.

When supply of water to the ablutionary fitting is shut off, the remaining or residual water in the passageways 224 may be subject to a significant amount of contact surface area and a limited volume within the nozzle 204 and about the plurality of arms 222. The contact surface area and limited volume may enable the residual water, via surface tension and the like, to latch onto the nozzle 204 and arms 222 or otherwise become slowed or stopped between the nozzle 204 and the nozzle pin 208. This may limit or prevent the residual water from leaking or dripping from the outlets of the ablutionary fitting. Preferably, the passageways 224 may be sized such that droplets of water remaining therewithin are bound via sufficient surface tension within each passageway 224 to be retained within the passageways 224. Such surface tension may facilitate maintaining water in the passageways 224 and preventing water leakage or dripping from the nozzles 204, until the surface tension forces are overcome by water flow through the nozzles 204 at a suitable pressure. For example, the surface tension forces maintaining the water in the passageways 224 may be overcome by flow of water through the nozzles 204 when the water supply to the ablutionary fitting is turned on.

The nozzle configuration 200 may operate via the surface tension between the residual water and the surface area between the nozzles 204 and the nozzle pins 208 to facilitate automated leak or drip prevention or reduction when water supply to the ablutionary fitting is shut off. In this way, the nozzle configuration 200 may obviate the need for moving parts, e.g., valves or other active closing mechanism, to limit or prevent water from leaking or dripping from the nozzles 204 and, ultimately, out of the ablutionary fitting. Moreover, the nozzle configuration 200 may allow the nozzles 204 and passageways 224 to remain open while also facilitating limiting or preventing any residual or unintentional water flow through the nozzles 204 when water flow is shut off. Advantageously, the nozzle configuration 200 may reduce the likelihood of any excess or residual water within the nozzles 204 leaking or dripping from the ablutionary fitting due to the surface tension forces facilitated via the nozzle pins 208.

Additionally, the nozzle configuration 200 may obviate the need for mechanical means for coupling or mounting the nozzle inserts 206 on the nozzle base 202. For example, the nozzle inserts 206 may be coupled or mounted to the nozzle base 202 without the use of screws, couplings, adhesives, etc. The nozzle inserts 206, including the functionalities of the nozzle pins 208, as described herein, rely on surface tension and pressure, depending on water flow, to selective allow and limit or restrict flow of water through the nozzles 204. This can reduce complexity relative to alternative leak prevention systems and enable a more precise and consistent system to limit or prevent water leakage.

The nozzle pins 208 may be constructed of a flexible material, such as silicone, rubber, thermoplastic elastomer (TPE), or the like, or a combination thereof. Such material, at least in part, may provide flexibility to the nozzle pins 208. Such flexibility may facilitate inserting the nozzle pins 208 into the nozzle holes 212. Additionally or alternatively, the flexibility of the nozzle pins 208 may enable the arms 222 to bend or otherwise adapt into the nozzle holes 212.

Referring to FIG. 6, the nozzle pins 208 and/or the nozzles 204 may be configured with various shapes and designs to facilitate limiting or preventing leaking or dripping of water from the nozzles 204. Preferably, the nozzle pins 208 may be sized and shaped for insertion in the nozzle holes 212 to a certain or predefined depth. For example, the nozzle pins 208 may be elongate and constructed with a tapered dimension along a length of the nozzle pins 208, e.g., with a cone-like shape. The nozzle holes 212 may be substantially parallel or symmetric along a first or inlet portion and the nozzle holes 212 may taper in dimension or narrow at an end portion. Additionally or alternatively, the end portion of the nozzle holes 212 may be sloped or angled. The end portion of the nozzle pins 208 may terminate in length proximate to or prior to the narrow and/or sloped end portion of the nozzle holes 212. For example, a terminal or bottom of the nozzle pins 208 may not be flush with or extend to the end portion of the nozzle holes 212. The narrow and/or end portion of the nozzle holes 212 may be configured to act as a choke point that facilitates limiting or preventing leaking or dripping of water from the nozzles 204 and the outlets of the ablutionary fitting. Avoid or empty space 226 may remain within the nozzle holes 212 at the choke point, which may facilitate limiting or preventing water leakage prior to the end of the length of the nozzle holes 212.

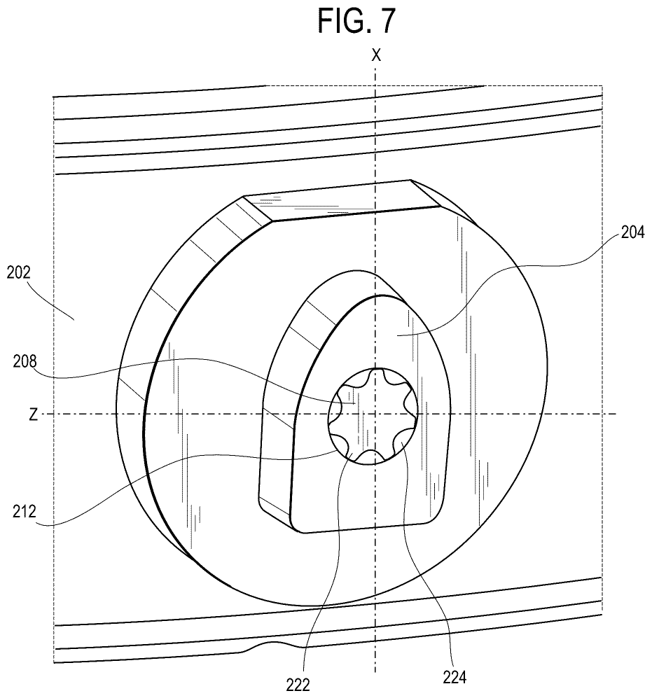

FIG. 7 depicts a cross-sectional view across an X-Z plane of the nozzle configuration 200 showing a nozzle pin 208 received by a nozzle hole 212 of a nozzle 204. The star shaped cross section of the nozzle pin 208 is shown with the flexible arms 222 extending outwardly within the nozzle hole 212. For example, the nozzle pin 208 may comprise seven, flexible arms 222 and may define seven discrete passageways 224 in the nozzle hole 212.

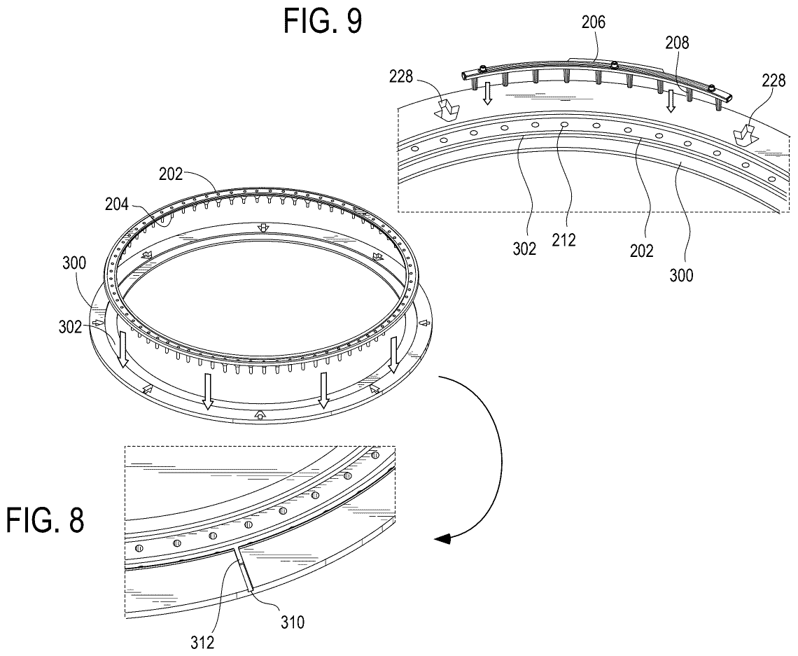

FIG. 8 depicts a first operation of an example method for assembling an ablutionary fitting with the nozzle configuration 200. A lower plate 300 comprising a ring nest 302 may be provided for coupling with or into a housing for an ablutionary fitting. For example, the lower plate 300 may form or may be coupled to the base 108 of the housing 104 of FIG. 1. The nozzle base 202 including the nozzles 204 may be received by, mounted on or within, or otherwise coupled to the ring nest 302. The ring nest 302 may comprise openings defining the outlets of the ablutionary fitting and the nozzles 204 may be received via the openings. Additionally or alternatively, the nozzles 204 may define the outlets of the ablutionary fitting when assembled with the lower plate 300.

The nozzles 204 may be integrated with the nozzle base 202. Alternatively, the nozzles 204 may be coupled with the nozzle base 202, e.g., via insertion of the nozzles 204 into a recessed portion of the nozzle base 202. The nozzles 204 may be coupled to the nozzle base 202 individually or in sections of two or more.

The lower plate 300 and the nozzle base 202 may include complementing alignment features 310, 312 that enable orienting and aligning the nozzle base 202 in the ring nest 302. For example, the lower plate 300 may include one or more alignment grooves 310 extending radially from the ring nest 302, e.g., radially outward from the ring nest 302. The nozzle base 202 may include one or more alignment tabs 312 that may be received via the alignment grooves 310. The alignment features 310, 312 may facilitate aligning the nozzles 204 with respective openings or outlets in the ring nest 302.

FIG. 9 depicts a second operation of the example method for assembling an ablutionary fitting with the nozzle configuration 200. The operation of FIG. 9 may be performed after the operation of FIG. 8. The nozzle inserts 206 may be coupled or mounted to the nozzle base 202 when the nozzle base 202 is coupled to the lower plate 300. However, the nozzle inserts 206 may be coupled to or mounted to the nozzle base 202 before the nozzle base 202 is coupled to the lower plate 300. The nozzle pins 208 may be configured to align with and insert into the associated nozzle holes 212 of the nozzle base 202.

One or more visual alignment guides 228, such as arrows, markings, or the like may indicate particular or recommended alignments for each nozzle insert 206 and/or each nozzle pin 208. The alignment guides 228 may be spaced apart for any particular size of the ring nest 302, the nozzle base 202, the number of nozzle inserts 206, the number of nozzle holes 212, the number of nozzle pins 208, the size of the lower plate 300 or ablutionary fitting, the number of outlets of the ablutionary fitting, etc. Each alignment guide 228 may indicate where each respective side of each nozzle insert 206 should be inserted for most effective alignment of each nozzle insert 206 and each nozzle pin 208. This may facilitate quick, efficient, and simplistic assembly of the ablutionary fitting. Preferably, the assembly of FIGS. 8 and 9 may not require any mechanical means to couple or otherwise assemble the nozzle base 202, the nozzles 204, the nozzle inserts 206, the lower plate 300, and the ring nest 302, the fixing between the lower nest 302, nozzle ring nest 304, nozzles 306, or nozzle inserts 314.

The lower plate 300 assembled with the nozzle base 202 and nozzle insert(s) 206 as shown in FIGS. 8 and 9 may then be coupled to or integrated with a remainder of the housing of the ablutionary fitting to complete the assembly.

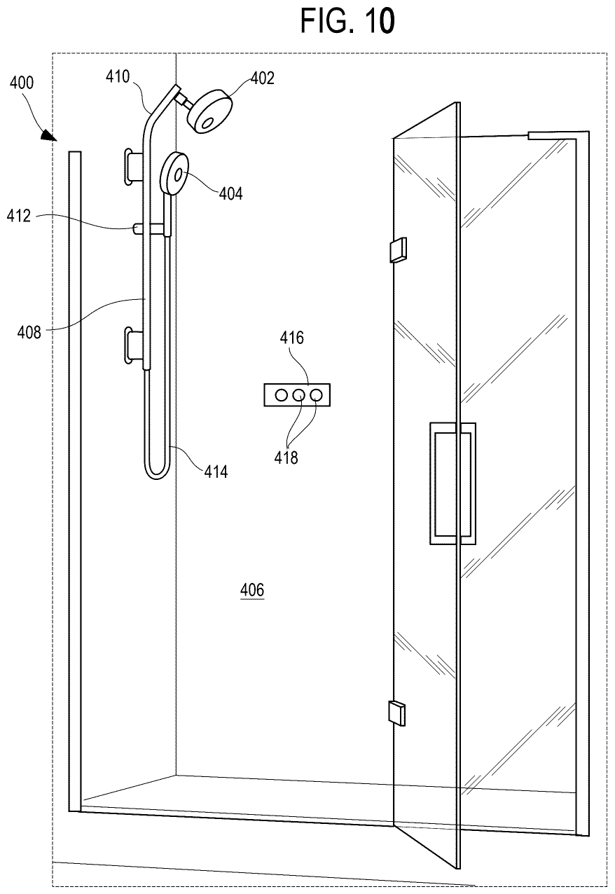

FIG. 10 depicts an example of an ablutionary system 400, such as a shower system. The ablutionary system 400 may include one or more outlet fittings or ablutionary fittings 402, 404 configured to dispense water into a space 406, e.g., a shower space. The ablutionary fittings 402, 404 may include a first ablutionary fitting 402, e.g., a shower head, a second ablutionary fitting 404, e.g., a hand spray, or a combination thereof to dispense water into the space 406. The first ablutionary fitting 402 and/or the second ablutionary fitting 404 may include similar features and components as the ablutionary fitting 100 of FIG. 1. The first ablutionary fitting 402 may be mounted to a support structure adjacent the space 406 via a riser 408. For example, the riser 408 may mount the first ablutionary fitting 402 to a side wall, a ceiling, or another support structure. An overhead arm 410 may be connected between the riser 408 and the first ablutionary fitting 402. The overhead arm 410 may be integrated with the slide bar 408 or coupled to the slide bar 408. The second ablutionary fitting 404 may be detachably mounted to the riser 408 via a bracket 412. A flexible hose 414 may be connected between the second ablutionary fitting 404 and the riser 408. The second ablutionary fitting 404 may be removable or detachable from the bracket 412 to allow a user to hold the second ablutionary fitting 404 and manually direct the water being dispensed from the second ablutionary fitting 404. The flexible hose 414 may provide slack between the second ablutionary fitting 404 and the riser 408 to allow a range of movement of the second ablutionary fitting 404 within the space 406 while dispensing water.

The shower system 400 may include a plumbing system configured to supply water to the ablutionary fittings 402, 404. The plumbing system may be substantially or entirely located behind a wall or partition and isolated from the space 406. One or more lines or conduits of the plumbing system may fluidly connect through the wall or partition with the ablutionary fittings 402, 404. Water supplied to the first ablutionary fitting 402 may flow from the plumbing system through the riser 408 and the overhead arm 410. Water supplied to the second ablutionary fitting 404 may flow from the plumbing system through the riser and the flexible hose 414.

The first ablutionary fitting 402 and/or the second ablutionary fitting 404 may incorporate a nozzle configuration, e.g., the nozzle configuration 200, to selectively allow and limit or restrict water flow through the first ablutionary fitting 402 and/or the second ablutionary fitting 404. For example, when water is supplied to the first ablutionary fitting 402 and/or the second ablutionary fitting 404, the nozzle configuration may allow the water to flow through and be dispensed by the ablutionary fitting 402 and/or the second ablutionary fitting 404. When water is shut off to the first ablutionary fitting 402 and/or the second ablutionary fitting 404, the nozzle configuration may limit or prevent water from leaking or dripping out from the first ablutionary fitting 402 and/or the second ablutionary fitting 404 as described herein.

A user may selectively turn on or off the water supplied to the first ablutionary fitting 402 and/or the second ablutionary fitting 404 via a user interface 416. The user interface 416 may be mounted on a support structure adjacent to the space 406. For example, the user interface 416 may be mounted on a side wall. The user interface 416 may include user input devices 418 for receiving user inputs associated with the water supplied to the ablutionary fittings 402, 404. The user input devices 418 may include manual input devices such as control buttons, knobs, dials, switches, triggers, or any other type of manual input device. Additionally or alternatively, the user input devices 418 may include a touchscreen display, such as an LED or LCD display, configured to receive user inputs. The user input devices 418 may allow the user to control flow rate, pressure, temperature, and/or another condition of water being dispensed via the ablutionary fittings 402, 404. Additionally or alternatively, the user input devices 418 may allow the user to control whether water is dispensed via the first ablutionary fitting 402, the second ablutionary fitting 404, or a combination thereof. The controls enabled by the user interface 416 are provided by way of example and are not an exhaustive list of functions. The user interface 416 may be operable to control any desired functions of the ablutionary system 400.

The present disclosure is not limited to the details or methodology set forth in the description or illustrated in the figures. The terminology used in this disclosure is for the purpose of description only and should not be regarded as limiting. As is evident from the foregoing description, certain aspects of the present invention are not limited by the particular details of the examples illustrated, and it is therefore contemplated that other modifications, applications, variations, or equivalents thereof, will occur to those skilled in the art. Many such changes, modifications, variations, and other uses and applications of the present constructions will become apparent to those skilled in the art after considering the specification and the accompanying drawings. In addition, unless expressly stated otherwise or the context clearly indicates otherwise, all of the accompanying drawings are not to scale. All such changes, modifications, variations, and other uses and applications which do not depart from the spirit and scope of the present inventions are deemed to be covered by the inventions which are limited only by the claims which follow.

The embodiments are not limited to the details of the configuration and arrangement of components set forth in the following description or illustrated in the accompanying drawings. The embodiments are capable of being practiced or of being carried out in various ways. Also, it is to be understood that the phraseology and terminology used in this disclosure are for the purpose of description and should not be regarded as limiting. When introducing elements of various embodiments of the present disclosure, the articles “a,” “an,” and “the” are intended to mean that there are one or more of the elements. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. References to “one embodiment” or “an embodiment” of the present disclosure are not intended to be interpreted as excluding the existence of additional embodiments that also incorporate the recited features. The terms “upstream” and “downstream” refer to a flow direction of fluid through a conduit.

It should be understood that various aspects disclosed may be combined in different combinations than the combinations specifically presented in the description and accompanying drawings. It should also be understood that, depending on the example, certain acts or events of any of the processes or methods described may be performed in a different sequence, may be added, merged, or left out altogether (e.g., all described acts or events may not be necessary to carry out the techniques). In addition, while certain aspects of this disclosure are described as being performed by a single component, module or unit for purposes of clarity, it should be understood that the techniques of this disclosure may be performed by a combination of components, units or modules, and vice versa. Where individual components, units or modules are depicted, such components, units or modules may be integrated to cooperatively perform the functions of the individual components, units or modules unless expressly stated otherwise or the context clearly indicates otherwise.

The specific embodiments described in this disclosure have been illustrated by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed in this disclosure are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

While the present disclosure has been described with respect to a number of embodiments and examples, those skilled in the art, having benefit of this disclosure, will appreciate that other embodiments can be devised which do not depart from the scope and spirit of the present disclosure.

What is claimed is:

1. An ablutionary fitting comprising:
a housing configured to receive water; and
a nozzle configuration coupled to the housing, wherein the nozzle configuration includes:
a plurality of nozzles for dispensing the water from the housing; and
a plurality of nozzle pins positioned in the plurality of nozzles, wherein each nozzle pin is configured to selectively allow and limit flow of the water through an associated nozzle of the plurality of nozzles in response to variations in pressure of the water.

2. The ablutionary fitting of claim 1, wherein the nozzle configuration includes a nozzle base including the plurality of nozzles and a nozzle insert including the plurality of nozzle pins, wherein the nozzle insert is positioned within a recess of the nozzle base.

3. The ablutionary fitting of claim 2, wherein the nozzle insert includes a plurality of nozzle insert segments that cooperatively define the nozzle insert, wherein each nozzle insert segment includes one or more of the plurality of nozzle pins.

4. The ablutionary fitting of claim 2, wherein the nozzle insert includes positioning features that facilitate maintaining a position of the nozzle insert in the recess.

5. The ablutionary fitting of claim 4, wherein the positioning features include bosses protruding outwardly from a main body of the nozzle insert, wherein the bosses facilitate limiting movement of the nozzle insert relative to the nozzle base.

6. The ablutionary fitting of claim 5, wherein the bosses include height bosses positioned proximate a floor of the recess, wherein the height bosses facilitate limiting downward movement of the nozzle insert relative to the nozzle base.

7. The ablutionary fitting of claim 5, wherein the bosses include anti-removal bosses protruding upwardly from the main body of the nozzle insert, wherein the anti-removal bosses facilitate limiting upward movement of the nozzle insert relative to the nozzle base.

8. The ablutionary fitting of claim 2, wherein flow passages are defined between the nozzle insert and the recess to allow the water received by the housing to flow toward the nozzles.

9. The ablutionary fitting of claim 1, wherein each nozzle pin defines discrete flow passages in the associated nozzle.

10. The ablutionary fitting of claim 1, wherein the nozzle insert includes one or more stiffening ribs.

11. A nozzle configuration for an ablutionary fitting, the nozzle configuration comprising:
a nozzle base couplable to a housing of the ablutionary fitting, the nozzle base including a plurality of nozzles configured to dispense water; and
a plurality of nozzle pins positioned in the plurality of nozzles, wherein each nozzle pin is configured to selectively allow and limit flow of the water through an associated nozzle of the plurality of nozzles in response to variations in pressure of the water.

12. The nozzle configuration of claim 11, wherein the plurality of nozzle pins is constructed of a flexible material.

13. The nozzle configuration of claim 11, wherein each nozzle pin includes a plurality of arms extending outwardly within the associated nozzle, wherein the plurality of arms defines discrete flow passages in the nozzle.

14. The nozzle configuration of claim 11, wherein the nozzle base includes a recess for the water to flow to the plurality of nozzles, the nozzle configuration further comprising a nozzle insert including the plurality of nozzle pins, wherein the nozzle insert is positioned within the recess of the nozzle base.

15. The nozzle configuration of claim 11, wherein the nozzle insert includes positioning features that facilitate maintaining a position of the nozzle insert in the recess.

16. The nozzle configuration of claim 11, wherein the nozzle insert includes one or more stiffening ribs.

17. An ablutionary system comprising:
an ablutionary fixture positioned proximate an ablutionary space; and
an ablutionary fitting mounted within the ablutionary space via the ablutionary fixture, the ablutionary fitting including:
a housing configured to receive water; and
a nozzle configuration coupled to the housing, wherein the nozzle configuration includes:
a plurality of nozzles for dispensing the water from the housing into the ablutionary space; and
a plurality of nozzle pins positioned in the plurality of nozzles, wherein each nozzle pin is configured to selectively allow and limit flow of the water through an associated nozzle of the plurality of nozzles in response to variations in pressure of the water.

18. The ablutionary system of claim 17, wherein the ablutionary fitting includes a shower head.

19. The ablutionary system of claim 17, wherein the ablutionary fixture is configured to supply the water to the ablutionary fitting, and wherein each nozzle pin is configured to selectively allow the flow of the water through the associated nozzle when the water is being supplied to the ablutionary fitting and to selectively limit the flow of the water through the associated nozzle when the supply of the water is shut off.

20. The ablutionary system of claim 17, wherein the nozzle configuration includes a nozzle base including the plurality of nozzles and a nozzle insert including the plurality of nozzle pins, wherein the nozzle insert is positioned within a recess of the nozzle base.
